(19) United States
(12) Patent Application Publication
(10) Pub. No.: US 2025/0369202 A1
(43) Pub. Date: Dec. 4, 2025

(54) WAVE-ABSORBING METHOD AND DEVICE FOR MARINE PASTURE

(71) Applicant: Guangdong Ocean University, Zhanjiang (CN)

(72) Inventors: Yi Guan, Zhanjiang (CN); Tianyu Zhang, Zhanjiang (CN)

(21) Appl. No.: 18/917,413

(22) Filed: Oct. 16, 2024

(30) Foreign Application Priority Data
May 30, 2024 (CN) 202410683512.6

(51) Int. Cl. E02B 3/06

(52) U.S. Cl. CPC E02B 3/06

(57) ABSTRACT

The present disclosure provides a wave-absorbing method and device for a marine pasture. The method includes the following steps: obtaining relevant data of a marine pasture area; designing a plurality of deployment modes by using a wave-absorbing device; determining a wave-absorbing effect corresponding to each of the deployment modes; and selecting a deployment mode corresponding to the best wave-absorbing effect from all the deployment modes, and performing wave-absorbing in a marine pasture using the deployment mode corresponding to the best wave-absorbing effect. A wave-absorbing solution corresponding to the best wave-absorbing effect is selected for performing wave-absorbing in the marine pasture, and the layout of wave-absorbing devices can be flexibly adjusted according to different marine environment and weather conditions to achieve the optimal protection effect.

### CROSS-REFERENCE TO RELATED APPLICATION

This application claims priority of Chinese Patent Application No. 202410683512.6,n filed on May 30, 2024, the entire contents of which are incorporated herein by reference.

### TECHNICAL FIELD

The present disclosure relates to the technical field of marine pastures, and in particular to a wave-absorbing method and device for a marine pasture.

### BACKGROUND

Marine pasture, as a new mode of utilization of marine resources, not only plays an important role in improving the output of marine organisms and promoting the balance of marine ecology, but also has great significance in ensuring food safety and increasing fishermen's income. Through artificial or semi-artificial cultivation, stocking, protection and management of marine organisms in marine pasture, and the productivity and biodiversity of specific sea areas can be effectively improved. However, the operation of marine pasture faces many challenges, especially the problems of survival and stability under extreme weather conditions including typhoon.

Typhoon, as an extreme weather event with strong winds and heavy waves, poses a great threat to marine pasture. During the typhoon, the height of waves can be significantly increased, and strong winds can accelerate the flow of seawater, all of which can cause damage to marine pasture facilities in a variety of ways, including the following. 1) Physical structure damage of marine pasture facilities: marine pastures typically rely on physical structures including floating cages, anchoring systems and seabed fixtures to maintain their operations. The heavy waves and strong winds caused by typhoons can directly destroy these physical structures, resulting in serious damage or even complete failure of breeding facilities. 2) Ecological balance disturbance: typhoon also indirectly affects the ecological balance of marine pasture by changing the environmental factors including salinity, temperature and flow direction of seawater. Rapidly changing environmental conditions adversely affect the growth and reproduction of marine organisms and even lead to long-term changes in the ecosystem. 3) Economic loss: the direct physical damage and disturbance of ecological balance caused by typhoon eventually lead to economic losses. The repair or reconstruction of marine pasture facilities requires significant capital investment, and the loss of marine organisms directly reduces the source of fishermen's income. Therefore, it is an urgent technical problem to protect marine pasture from extreme weather, especially to effectively reduce the impact of typhoon on waves.

Currently, there are a number of wave-absorbing devices on the market for marine pasture that reduce the direct impact of waves on marine pasture through physical barriers or energy dissipation principles. However, in the existing wave-absorbing devices for marine pasture, the design of single wave-absorbing device is mainly focused on, including wave-absorbing block, floating breakwater, etc. Due to the complexity and variability of marine environment, it is difficult for a single type of wave-absorbing device to meet needs of all marine pastures.

Therefore, how to use these wave-absorbing devices to automatically and effectively protect against changes in the marine environment (including water depth and wave characteristics) in the face of large-scale natural disasters including typhoons is an urgent problem to be solved.

### SUMMARY

The present disclosure provides a wave-absorbing method and device for a marine pasture to solve the defects in the prior art that wave-absorbing cannot be performed in a targeted manner according to changes in marine environment.

A wave-absorbing method for a marine pasture includes the following steps:
step 1: obtaining relevant data of a marine pasture area; the relevant data including wave height, period, wavelength, wind speed, water depth and wave direction;
step 2: determining parameters of a wave-absorbing device, and designing a plurality of deployment modes according to the parameters of the wave-absorbing device;
step 3: determining a wave-absorbing effect corresponding to each of the deployment modes according to the relevant data of the marine pasture area and the plurality of deployment modes; and
step 4: selecting a deployment mode corresponding to the best wave-absorbing effect from all the deployment modes, and performing wave-absorbing in the marine pasture using the deployment mode corresponding to the best wave-absorbing effect.

Further, according to the wave-absorbing method for a marine pasture as described above, the parameters of the wave-absorbing device include size, shape, and material.

Further, according to the wave-absorbing method for a marine pasture as described above, the plurality of deployment modes include:
a single wave-absorbing device mode, a multiple single-row spacing mode, a multiple-row spacing parallel mode, a multiple-row spacing dislocation mode and a multiple-row spacing trapezoidal mode.

Further, according to the wave-absorbing method for a marine pasture as described above, step 3 includes the following steps:
step 31: determining a direction of a wave on the marine pasture, and determining a deployment direction of the wave-absorbing device according to the direction of the wave; the direction of the wave being perpendicular to the deployment direction of the wave-absorbing device;
step 32: comprehensively determining a wave-absorbing effect corresponding to each of the deployment modes according to the relevant data of the marine pasture area, the deployment direction of the wave-absorbing device, and the plurality of deployment modes corresponding to the wave-absorbing device; and
step 33: converting the wave-absorbing effect corresponding to each of the deployment modes into a visual graph, and displaying different wave-absorbing effects through graphs.

Further, according to the wave-absorbing method for a marine pasture as described above, the wave-absorbing effect includes an area covered by the wave-absorbing effect, a wave reduction percentage and a user preference.

Further, according to the wave-absorbing method for a marine pasture as described above, the performing wave-absorbing in the marine pasture using the deployment mode corresponding to the best wave-absorbing effect includes:
performing wave-absorbing in the marine pasture according to the location, quantity, layout details of the wave-absorbing device and an area covered by expected wave-absorbing effect.

Further, according to the wave-absorbing method for a marine pasture as described above, the wave-absorbing device is in a shape of a strip plane.

Further, according to the wave-absorbing method for a marine pasture as described above, a length of the wave-absorbing device is greater than a wavelength of an expected wave, and a width of the wave-absorbing device is greater than a pre-set width.

Further, according to the wave-absorbing method for a marine pasture as described above, materials of the wave-absorbing device include polystyrene or polyurethane foam material, treated metal or high density polyethylene material.

A device for implementing the wave-absorbing method for a marine pasture as described above includes:
an acquisition unit, for acquiring relevant data of a marine pasture area; the relevant data including wave height, period, wavelength, wind speed, water depth and wave direction;
a determination unit, for determining a wave-absorbing device and using the wave-absorbing device to design a plurality of deployment modes; and
the determination unit being further used for determining a wave-absorbing effect corresponding to each of the deployment modes according to the relevant data of the marine pasture area and the plurality of deployment modes; and
a selection unit, for selecting a deployment mode corresponding to the best wave-absorbing effect from all the deployment modes, and performing wave-absorbing in the marine pasture using the deployment mode corresponding to the best wave-absorbing effect.

According to the wave-absorbing method and device for a marine pasture provided by the present disclosure, the wave-absorbing solution is designed flexibly through the relevant data of the marine pasture area and the plurality of deployment modes corresponding to the wave-absorbing device, and the wave-absorbing solution with the best wave-absorbing effect is selected from all the wave-absorbing solutions for absorbing waves in the marine pasture, thereby achieving the optimal protection effect by adjusting the layout of the wave-absorbing device according to different marine environments (water depth, wave characteristics) and weather conditions, and the method and device are more suitable for wave-absorbing scenes in a wide range of marine pasture.

### BRIEF DESCRIPTION OF THE DRAWINGS

To explain the present disclosure or the technical solutions in the prior art more clearly, a brief description will be given below with reference to the accompanying drawings which are used in the description of the examples or the prior art. Obviously, the drawings in the description below are some examples of the present disclosure, and other drawings can be obtained according to these drawings without creative work for those ordinary skilled in the art.

FIG. 1 is a flow chart of a wave-absorbing method for a marine pasture of the present disclosure;

FIG. 2 demonstrates an effect of a wave-absorbing device according to Example 1 of the present disclosure;

FIG. 3 demonstrates an effect of a wave-absorbing device according to Example 2 of the present disclosure; and

FIG. 4 demonstrates an effect of a wave-absorbing device according to Example 3 of the present disclosure.

### DETAILED DESCRIPTION

To make the objects, technical solutions and advantages of the present disclosure more clear, technical solutions of the present disclosure will be described clearly and completely in the following with reference to the drawings of the present disclosure. Obviously, all the described examples are only some, rather than all examples of the present disclosure. On the basis of the examples in the present disclosure, all other examples obtained by those ordinary skilled in the art without creative efforts belong to the protection scope of the present disclosure.

The method provided by the present disclosure is suitable for application scenarios in a wide range of marine pasture.

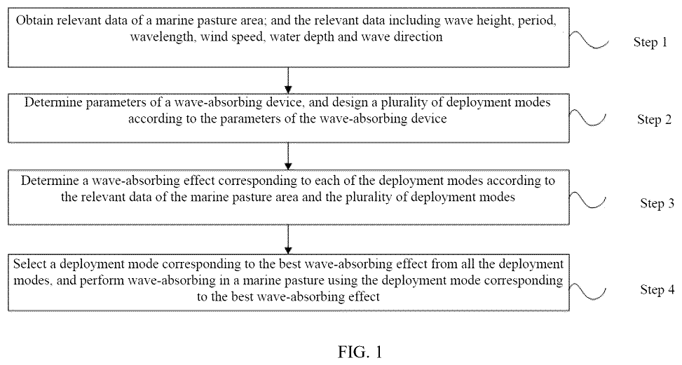

FIG. 1 is a flow chart of a wave-absorbing method for a marine pasture of the present disclosure, as shown in FIG. 1, the method includes the following steps.
Step 1: relevant data of a marine pasture area is obtained; and the relevant data includes wave height, period, wavelength, wind speed, water depth and wave direction.

Specifically, the data including wave height, period, wavelength, wind speed, water depth, and wave direction are collected in the marine pasture area.
Step 2: parameters of a wave-absorbing device are determined, and a plurality of deployment modes are designed according to the parameters of the wave-absorbing device.

Specifically, a shape of the wave-absorbing device is determined to be a strip plane, and a length of the wave-absorbing device is to be at least equivalent to a wavelength of expected wave. Longer devices are generally more efficient because a wider range of waves can be covered. A width of the wave-absorbing device is to be larger than a pre-set width, which is set according to actual requirements, and the larger the width, the stronger the stability and absorbent capacity of the device. Materials of the wave-absorbing device include the following.

Floating material: polystyrene or polyurethane foam, can ensure buoyancy and flexibility of the device.

Durable materials: materials resistant to corrosion and marine organisms attachment, including specially treated metals or high density polyethylene, can improve the durability and maintenance cycle of the device.
Step 3: a wave-absorbing effect corresponding to each of the deployment modes is determined according to the relevant data of the marine pasture area and the plurality of deployment modes.

Specifically, in the present disclosure, the wave-absorbing effect is simulated by importing preliminary deployment modes into Delft 3D software.
Step 4: a deployment mode corresponding to the best wave-absorbing effect is selected from all the deployment modes, and wave-absorbing is performed in the marine pasture using the deployment mode corresponding to the best wave-absorbing effect.

According to the wave-absorbing method and device for a marine pasture provided by the present disclosure, the wave-absorbing solution is designed flexibly through the relevant data of the marine pasture area and the plurality of deployment modes corresponding to the wave-absorbing device, and the wave-absorbing solution with the best wave-absorbing effect is selected from all the wave-absorbing solutions for absorbing waves in the marine pasture, thereby achieving the optimal protection effect by adjusting the layout of the wave-absorbing device according to different marine environments (water depth, wave characteristics) and weather conditions, and the method and device are more suitable for wave-absorbing scenes in a wide range of marine pasture.

Moreover, the present disclosure can effectively reduce the damage of waves to the marine pasture. At the same time, by optimizing the arrangement of wave-absorbing devices, unnecessary device investment is reduced, and the balance between environmental protection and economic benefits is achieved.

Further, the plurality of deployment modes include a single wave-absorbing device mode, a multiple single-row spacing mode, a multiple-row spacing parallel mode, a multiple-row spacing dislocation mode and a multiple-row spacing trapezoidal mode.

Specifically, the deployment mode of the wave-absorbing device is not limited in the present disclosure, and other modes capable of achieving the wave-absorbing object in addition to the various deployment modes listed in the present disclosure can be used as the wave-absorbing solution of the present disclosure.

Further, the wave-absorbing effect includes an area covered by the wave-absorbing effect, a wave reduction percentage and a user preference.

The present disclosure provides an accurate wave-absorbing effect evaluation for a manager of a marine pasture through the area covered by the wave-absorbing effect and the percentage of wave reduction, which is important for the planning and management of the marine pasture and enables the manager to make more reasonable decisions according to the actual wave-absorbing requirements and the result of the effect evaluation.

Further, the wave-absorbing effect corresponding to each of the deployment modes is determined according to the relevant data of the marine pasture area and the plurality of deployment modes, including the following steps.
Step 31: a direction of a wave on the marine pasture is determined, and a deployment direction of the wave-absorbing device is determined according to the direction of the wave; and the direction of the wave is perpendicular to the deployment direction of the wave-absorbing device.
Step 32: a wave-absorbing effect corresponding to each of the deployment modes is comprehensively determined according to the relevant data of the marine pasture area, the deployment direction of the wave-absorbing device, and the plurality of deployment modes corresponding to the wave-absorbing device.
Step 33: the corresponding wave-absorbing effect of each of the deployment modes is converted into a visual graph, and different wave-absorbing effects are displayed through graphs.

Specifically, the direction of the wave is firstly analyzed, the deployment direction of the wave-absorbing device is determined according to the direction of the wave, and the deployment direction of the wave-absorbing device needs to be perpendicular to the direction of the wave. Secondly, the deployment mode of the wave-absorbing device is set, and a preliminary deployment solution is generated for each mode. The mode is selected as a single device, multiple devices with single row spacing, multiple rows with parallel spacing, multiple rows with staggered spacing, and trapezoidal. Afterwards, the Delft 3D software is used to perform dynamic simulation, namely: the preliminary deployment solutions are imported into the Delft 3D software, and simulation parameters matching an actual environment are configured. The Delft 3D is mainly applied in free surface water environment. The software has a flexible framework, which can simulate two-dimensional and three-dimensional flow, wave, water quality, ecology, sediment transport and under river bed landform, as well as the interaction between various processes. In the present disclosure, a wave module of Delft3D is employed to simulate the wave-absorbing effect. A modeling process includes: establishing a spatial scale for simulation, establishing a grid, interpolating water depth data, setting offshore wave boundary conditions (wave height, wavelength, wave period, wave direction and other parameters), model correction and verification. In the simulation, the wave-absorbing device is configured as an obstacle capable of blocking waves and laid in the grid, and the wave-absorbing efficiency can be adjusted by input parameters. The simulation is then performed, and data on the wave-absorbing effect for each of the deployment solutions is collected. Model output results include a series of parameters including wave height, wave direction, wave period and wavelength of two-dimensional space field. Finally, the parameters of wave-absorbing effect are calculated. For the simulation results of the Delft 3D software, key wave-absorbing effect parameters are calculated, including the area covered by the wave-absorbing effect and the percentage of wave reduction. The wave-absorbing effect of each of the deployment solutions is analyzed to determine which deployment mode and configuration can maximize the area covered by the wave-absorbing effect and minimize the wave. At the same time, the simulation results (including the parameters of wave-absorbing effect) can be converted into graphs by using visualization tools, and the wave-absorbing effect of different deployment solutions can be displayed visually. Finally, the simulation results, the wave-absorbing effect parameters and the user preference are combined to determine a final deployment solution of the wave-absorbing device, and detailed parameters of the final solution are recorded, including the position, number, deployment details and expected wave-absorbing effect parameters (coverage area) of the wave-absorbing device.

According to the method provided by the present disclosure, the wave-absorbing effect corresponding to each of the deployment modes is converted into a visual graph, allowing users to intuitively see the protection effect according to different configurations of the wave-absorbing device, which is very important for non-professionals to understand and apply technology, and the interactivity and usability of the system are enhanced. In addition, the wave-absorbing effect is developed as a visual effect system, and the users can intuitively see the wave-absorbing effect in different configurations and perform adjustment and optimization accordingly. This not only helps to improve the user's understanding of the system performance, but also promotes iterative improvements in the design of the wave-absorbing system. Furthermore, the user experience is considered by simplifying the configuration and management process of the system, which improves the management efficiency and usability of the system, and enables the manager of marine pasture to use the wave-absorbing system efficiently even without deep technical background.

Further, the wave-absorbing effect includes an area covered by the wave-absorbing effect, a wave reduction percentage and a user preference. Performing wave-absorbing in the marine pasture using the deployment mode corresponding to the best wave-absorbing effect includes: performing wave-absorbing on the marine pasture according to the position, quantity, layout details of the wave-absorbing device and the area covered by expected wave-absorbing effect.

The method provided by the present disclosure can simulate and display the protection effect of wave impact in real time according to the configuration (including size, shape, and position, etc.) of the wave-absorbing device input by the users. The scientificity and effectiveness of the wave-absorbing system in the protection of marine pasture are improved, and the interactivity and usability of the system are enhanced by introducing visualization technology. The innovative solution, which comprehensively considers the layout and effect visualization of wave-absorbing devices, not only helps to improve the viability of marine pastures under extreme weather conditions, but also provides a new technical reference for the field of marine engineering, with broad application prospects and commercial value.

Further, the wave-absorbing device is in a shape of a strip plane.

According to the method provided by the present disclosure, the workload of maintenance and repair of the wave-absorbing device is reduced even in a severe marine environment by designing the wave-absorbing device into a strip plane shape.

### Example 1

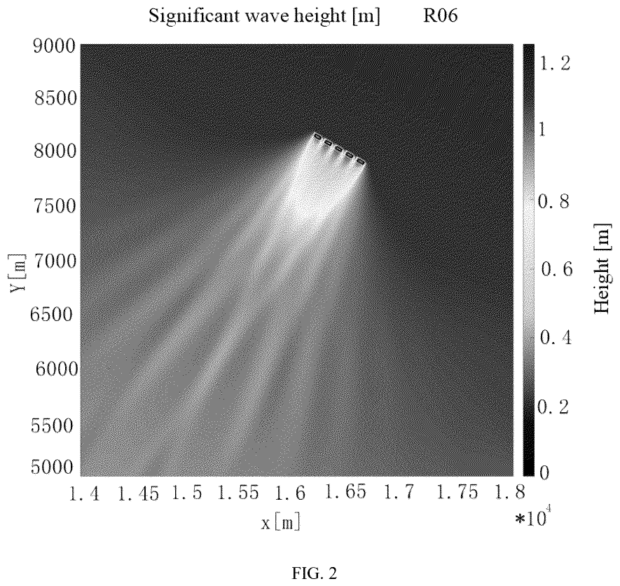

As shown in FIG. 2, this example demonstrates an effect of arranging 5 wave-absorbing devices side by side, and the wave-absorbing devices in this example are set to 60 m*20 m with spacing of 60 m between devices. Wave-absorbing effect on wave: the significant wave height of wave is reduced by 50%.

### Example 2

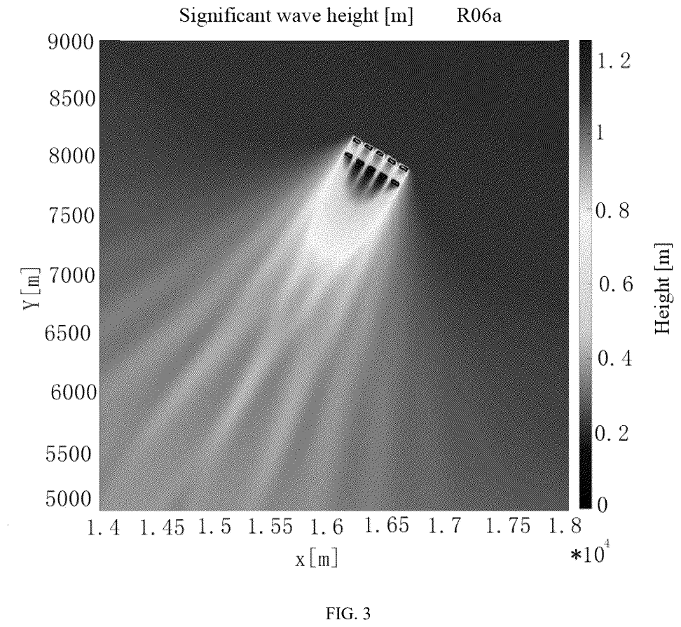

As shown in FIG. 3, this example demonstrates an effect of arranging 10 wave-absorbing devices in two rows, and each device is set to 60 m*20 m, with spacing of 60 m between devices in a same row and spacing of 120 m between the two rows. The significant wave height of wave is reduced by 50%.

### Example 3

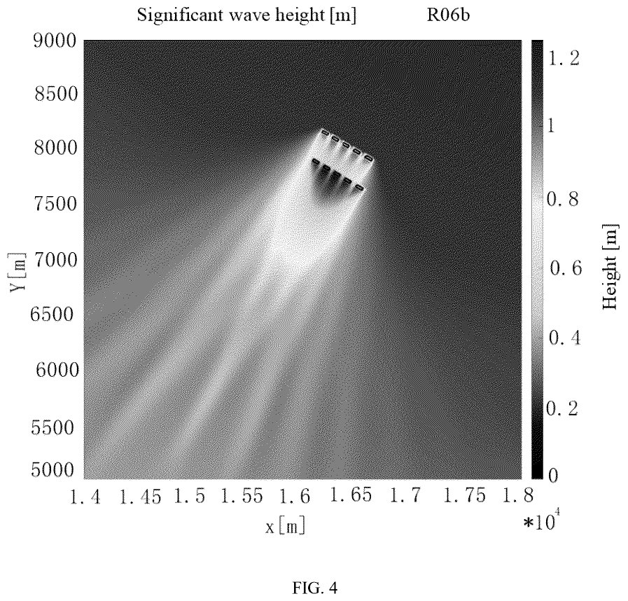

As shown in FIG. 4, this example demonstrates an effect of arranging 10 wave-absorbing devices in two staggered rows, and each device is set to 60 m*20 m, with spacing of 60 m between devices and spacing of 240 m between the two rows. The significant wave height of wave is reduced by 50%.

In the present disclosure, the wave-absorbing efficiency can be significantly improved by performing dynamic simulation using the Delft 3D software and optimizing the deployment solution in combination with environmental monitoring data. The simulation session ensures that the deployment solution of wave-absorbing devices can be accurately adjusted according to the actual marine environmental conditions, including wave direction and intensity, thereby minimizing wave energy and protecting the marine pasture from damage.

In summary, the method provided by the present disclosure improves the wave-absorbing efficiency, user experience and system adaptability.

The present disclosure also provides a device for the wave-absorbing method for a marine pasture, including:
an acquisition unit, for acquiring relevant data of the marine pasture area; the relevant data including wave height, period, wind speed, water depth and wave direction;
a determination unit, for determining a wave-absorbing device and using the wave-absorbing device to design a plurality of deployment modes;
the determination unit being further used for determining a wave-absorbing effect corresponding to each of the deployment modes according to the relevant data of the marine pasture area and the plurality of deployment modes; and
a selection unit, for selecting a deployment mode corresponding to the best wave-absorbing effect from all the deployment modes, and performing wave-absorbing in the marine pasture using the deployment mode corresponding to the best wave-absorbing effect.

Finally, it is to be noted that the above examples are only used to illustrate the technical solutions of the present disclosure, rather than limiting the present disclosure. Although the present disclosure has been described in detail with reference to the foregoing examples, those ordinary skilled in the art will understand that the technical solutions disclosed in the above examples can still be modified, or some of the technical features can be replaced by equivalents. These modifications and substitutions do not make the essence of the corresponding technical solutions depart from the spirit and scope of the technical solutions of various examples of the present disclosure.

1. A wave-absorbing method for a marine pasture, comprising the following steps:
step 1: obtaining relevant data of a marine pasture area; the relevant data comprising wave height, period, wavelength, wind speed, water depth and wave direction;
step 2: determining parameters of each of a plurality of wave-absorbing devices, and designing a plurality of deployment modes according to the parameters of the wave-absorbing device;
step 3: determining a wave-absorbing effect corresponding to each of the deployment modes according to the relevant data of the marine pasture area and the plurality of deployment modes; and
step 4: selecting a deployment mode corresponding to the best wave-absorbing effect from all the deployment modes, wherein the deployment mode corresponding to the best wave-absorbing effect is used for performing wave-absorbing in the marine pasture;
wherein the parameters of the wave-absorbing device a comprise size, shape, and material;
the step 2 comprises:
determining that the wave-absorbing device is in a shape of a strip plane, wherein a length of the wave-absorbing device is greater than a wavelength of an expected wave; and a width of the wave-absorbing device is greater than a pre-set width;
determining the material of the wave-absorbing device comprising a floating material and a durable material; and
determining, according to the comprise size, shape, and material of the wave-absorbing device, the plurality of deployment modes comprising
a multiple single-row spacing mode, a multiple-row spacing parallel mode, and a multiple-row spacing dislocation mode; wherein the multiple single-row spacing mode is: deploying at intervals multiple wave-absorbing devices in one row; the multiple-row spacing parallel mode is: deploying at intervals multiple wave-absorbing devices in multiple spaced rows aligned with each other; the multiple-row spacing dislocation mode is: deploying at intervals multiple wave-absorbing devices in multiple spaced rows misaligned with each other;
the step 3 comprises the following steps:
step 31: determining a direction of a wave on the marine pasture, and determining a deployment direction of the wave-absorbing device according to the direction of the wave; the direction of the wave being perpendicular to the deployment direction of the wave-absorbing device;
step 32: comprehensively determining a wave-absorbing effect corresponding to each of the deployment modes according to the relevant data of the marine pasture area, the deployment direction of the wave-absorbing device, and the plurality of deployment modes corresponding to the wave-absorbing device; and
step 33; converting the wave-absorbing effect corresponding to each of the deployment modes into a visual graph, and displaying different wave-absorbing effects through graphs; and
the deployment mode corresponding to the best wave-absorbing effect is used for:
performing wave-absorbing in the marine pasture according to position, quantity, layout details of the wave-absorbing device and an area covered by expected wave-absorbing effect.

2. The wave-absorbing method for a marine pasture according to claim 1, wherein the parameters of the wave-absorbing device comprise size, shape, and material.

3. The wave-absorbing method for a marine pasture according to claim 1, wherein the wave-absorbing effect comprises an area covered by the wave-absorbing effect and a wave reduction percentage.

4. (canceled)

5. (canceled)

6. The wave-absorbing method for a marine pasture according to claim 2, wherein materials of the wave-absorbing device comprise polystyrene or polyurethane foam material, and treated metal or high density polyethylene material.

7. (canceled)
